(19) United States
(12) Patent Application Publication
(10) Pub. No.: US 2026/0016633 A1
(43) Pub. Date: Jan. 15, 2026

(54) Bending Waveguide

(71) Applicant: Nippon Telegraph and Telephone Corporation, Chiyoda-ku, Tokyo (JP)

(72) Inventors: Yuichiro Ikuma, Musashino-shi, Tokyo (JP); Yusuke Nasu, Musashino-shi, Tokyo (JP)

(21) Appl. No.: 18/993,771

(22) PCT Filed: Jul. 19, 2022
(86) PCT No.: PCT/JP2022/028105

§ 371 Date: Jan. 13, 2025

(51) Int. Cl. G02B 6/125; G02B 6/12

(52) U.S. Cl. CPC G02B 6/125; G02B 2006/12119

(57) ABSTRACT

An optical waveguide of the present disclosure proposes a configuration of a bent waveguide having a novel configuration. For proposed four types of curves A, B, C, and D, a value obtained by differentiating a curvature along a waveguide is 0 at one end 1=0 and the other end 1=L of a bent waveguide. It is possible to suppress optical loss and inter-mode crosstalk occurring in the bent waveguide. Even in a bent waveguide having a waveguide width under a multimode condition, excellent inter-mode crosstalk characteristics and low loss are achieved as compared with the clothoid curve of the prior art.

### TECHNICAL FIELD

The present invention relates to an optical waveguide of an optical circuit, and more particularly to a bent waveguide.

### BACKGROUND ART

For increasing a communication capacity per device of optical communication devices, research and development of more compact and highly functional optical modules has been actively conducted. One of the promising technologies is silicon photonics (SiP).

Silicon photonics is a technology of producing an optical circuit using a waveguide formed on a silicon-on-insulator (SOI) wafer and using silicon (Si) as a core material and quartz glass (SiO₂) as a cladding material. A silicon waveguide has a large difference between relative refractive indices of the core and the cladding, and can confine light in a minute region, so that an extremely small optical circuit can be implemented.

However, a bent waveguide for converting a traveling direction of light on an optical circuit has a challenge that an optical loss occurs when a bending radius is small. When the bending radius is sufficiently increased to reduce the optical loss to a negligible extent, another challenge arises that the circuit size increases.

In order to address the challenges above, a bent waveguide having a different shape may be used instead of a common arc shape. One example is a clothoid curve in which the product of the length along a propagation direction and the curvature radius is constant. A bent waveguide using a clothoid curve can achieve a lower loss as compared with a waveguide having a common arc shape, but studies have been made to acquire a bending shape having a lower loss.

### CITATION LIST

### Non Patent Literature

Non Patent Literature 1: Xiaohui Jiang, Hao Wu, Daoxin Dai, “Low-loss and low-crosstalk multimode waveguide bend on silicon”, Optics Express, Vol. 26, No. 13 (2018)

### SUMMARY OF INVENTION

### Technical Problem

In particular, in a waveguide having a relatively large propagation loss such as a silicon waveguide, another characteristic may be required for the bent waveguide. This is low inter-mode crosstalk. The inter-mode crosstalk can be reduced by, for example, a wider waveguide designed under a multimode condition. However, it is necessary to satisfy a single-mode condition for the bent waveguide. If the bent waveguide having low inter-mode crosstalk is achieved even in multimode, the advantageous effects of the wider waveguide such as suppression of loss and reflection can be obtained from the bent waveguide portion, improving the overall device performance.

### Solution to Problem

One aspect of the present invention is a bent waveguide, in which a curvature radius r gradually varies from a first value (R1) at a first end to a second value (R2) at a second end, a curvature is represented by the reciprocal 1/r of the curvature radius, and a differential coefficient obtained by differentiating the curvature with a length I along the waveguide is 0 at the first end and the second end.

### Advantageous Effects of Invention

It is possible to provide a bent waveguide that is downsized and has low optical loss and low inter-mode crosstalk.

### BRIEF DESCRIPTION OF DRAWINGS

FIG. 1 is a diagram illustrating a configuration of a clothoid-curved bent waveguide including a recession curve.

FIG. 2 is a diagram illustrating a relationship between a curve length and a curvature of four types of proposed curves A to D.

FIG. 3 is a diagram illustrating derivation of x and y values for drawing four curves in Cartesian coordinates.

FIG. 4 is a diagram illustrating inter-mode crosstalk characteristics of four types of proposed curves A to D.

FIG. 5 is a table for comparing zero-order mode losses of bent waveguides according to four types of curves A to D.

FIG. 6 is a table for comparing zero-order mode loss under a single mode condition.

### DESCRIPTION OF EMBODIMENTS

An optical waveguide of the present disclosure provides a bent waveguide having a novel configuration. Characteristics of loss and inter-mode crosstalk of configurations of four types of bent waveguides will be described in comparison with a bent waveguide based on a clothoid curve of the prior art. For example, a direction conversion circuit is implemented by the bent waveguide.

First, characteristics of a clothoid curve widely used for a bent waveguide and design conditions required for the bent waveguide will also be described. Thereafter, configurations of four proposed bent waveguides will be described.

As described above, instead of the arc shape, a clothoid curve (Euler spiral) is used for a bent waveguide. In the clothoid curve, since a curvature radius continuously shifts from co to a predetermined value, the change in the propagation mode also becomes continuous, and the loss generated in the bent waveguide can be reduced. A curve in which the curvature continuously decreases, such as a clothoid curve, is also called a recession curve. The direction conversion of 90° in the clothoid curve is realized as follows using a recession curve.

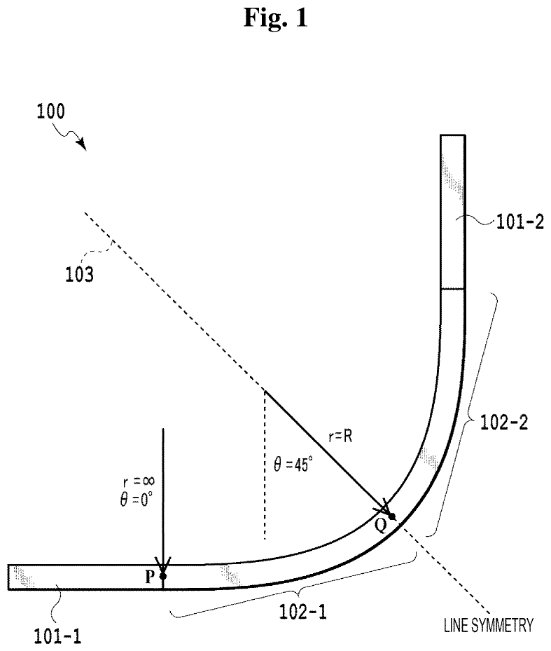

FIG. 1 is a diagram illustrating a configuration of a clothoid-curved bent waveguide including a recession curve. A waveguide 100 shown in FIG. 1 has a configuration in which two linear waveguides 101-1 and 101-2 arranged at an angle of 90° relatively are connected by two recession curves 102-1 and 102-2. Two recession curves 102-1 and 102-2 are formed so that a curvature radius r=∞ when an angle θ=0° (point P) and the curvature radius r=R when the angle θ=45° (point Q) are satisfied, and the two recession curves may be joined in line symmetry at a point of θ=45°. In this way, the curvature radius becomes ∞ at the positions of θ=0° and 90°, and the recession curves 102-1 and 102-2 can be coupled to the front and rear linear waveguides 101-1 and 101-2 in low loss. The waveguide 100 shown in FIG. 1 constitutes a direction conversion circuit.

A silicon waveguide is a waveguide that can achieve an extremely small optical circuit but has a relatively large propagation loss. As described above, for the silicon waveguide, the bent waveguide is required to have low inter-mode crosstalk.

For a silicon waveguide, the width of waveguide may be wider than a width that satisfies a single-mode condition, that is, the waveguide may be designed under a multimode condition. By designing under a multimode condition for widening a waveguide width, it is possible to reduce the overlap between a waveguide sidewall and an optical mode, as well as radiation loss and reflection due to the sidewall roughness. It is also possible to reduce a phase error caused by manufacturing fluctuation of a waveguide width and to reduce a peak intensity of light in the waveguide to suppress a non-linear effect.

However, such a wide waveguide is generally available only for a linear waveguide. This is because when the bent waveguide is widened for multimode, inter-mode coupling occurs from a 0th-order mode to a higher-order mode, causing inter-mode crosstalk. The inter-mode crosstalk from the 0th-order mode to the higher-order mode finally causes optical loss and/or group delay ripple, which are not preferable. Therefore, the bent waveguide has been designed to satisfy the single-mode condition.

The inventors have arrived at an idea that, if a bent waveguide having low inter-mode crosstalk is achieved even under a multimode condition, the advantageous effects of the wider waveguide such as suppression of loss and reflection can be obtained, improving the performance of a device using a silicon waveguide. Non Patent Literature 1 reports that by using the clothoid curve described above, inter-mode crosstalk can be suppressed to a low extent even when bending is performed with a wide width for multimode. However, the advantageous effects of reducing inter-mode crosstalk disclosed in Non Patent Literature 1 are not sufficiently obtained.

The configurations of the novel four types of bent waveguides according to the present disclosure and their excellent characteristics of inter-mode crosstalk and loss will be described hereinbelow. Unless otherwise noted, the term “curvature” is intended to represent the reciprocal 1/r of the curvature radius r. Since the sine (sin) and the cosine (cos) are different in phase only, a cosine is also referred to as a sine in some mathematical expressions with respect to a shape of the waveguide.

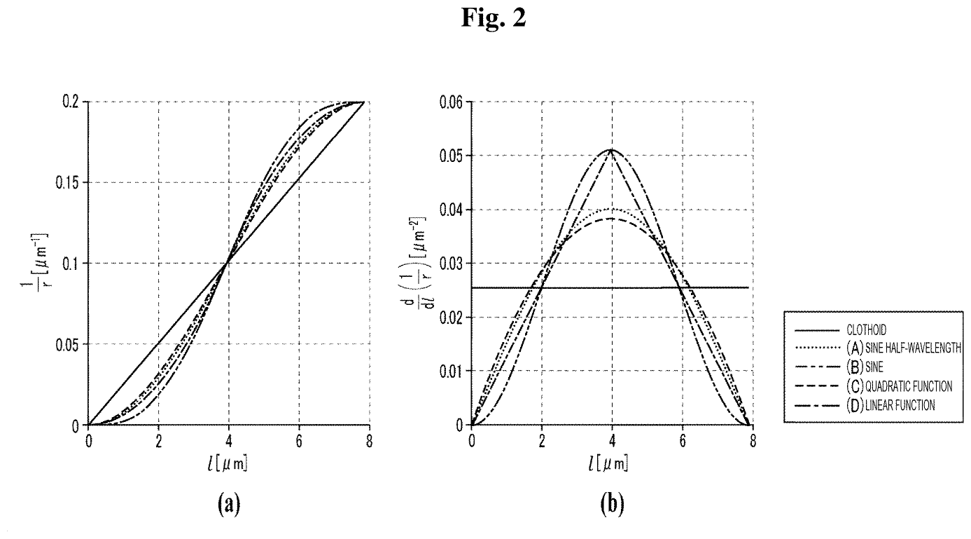

FIG. 2 is a diagram illustrating a relationship between a curve length and a curvature of four types of proposed curves A to D. FIG. 2(a) is a graph in which, for four types of curves A, B, C, and D, a length 1 (μm) along a curve from a connection point with a linear waveguide is indicated on the horizontal axis, and a curvature 1/r is indicated on the vertical axis. FIG. 2(b) is a graph in which the horizontal axis represents the length 1 (μm) along the curve, and the vertical axis represents the differentiation of the curvature 1. The two graphs also show clothoid curves for comparison. In the two graphs shown in FIG. 2, 1=0 corresponds to the point P in FIG. 1, with the curvature of 0. When the maximum value of 1, that is, the total length of the curve is represented by L, L=7.85 μm, which is a point at θ=45° corresponding to the point Q in FIG. 1. Here, r=R=5 μm. As will be described later, a relationship of 1=2rθ is established between r, 1, and θ in all types of curves shown in two graphs of FIG. 2.

Each of the four curves A, B, C, and D will be described hereinbelow.

Curve A: Sine half-wavelength

In the curve A, a differentiation (1/r)′ of the curvature is expressed by the following Equation
(1). In the range of 1=0 to L, a half-wavelength portion of a sine wave (sine) function is obtained, and thus, it is referred to as a sine half-wavelength curve.

$$\frac{1}{dl} ( \frac{1}{r} ) = \frac{π}{2 RL} sin \frac{π l}{L} \qquad Formula ( 1 )$$

When integration is performed while paying attention to a boundary condition of r=∞ at 1=0 and r=R at 1=L, the curvature is expressed by Equation (2), and a shape of the half-wavelength of the sine function is obtained although the phase is shifted.

$$\frac{1}{r} = \frac{1}{2 R} ( 1 - cos \frac{π l}{L} ) \qquad Formula ( 2 )$$

### Curve B: Sine

In the curve B, a differentiation (1/r)′ of the curvature is expressed by the following Equation (3). In the range of 1=0 to L, one wavelength portion of a sine wave (sine) function is obtained, and thus, it is referred to as a sine curve.

$$\frac{d}{dl} ( \frac{1}{r} ) = \frac{1}{RL} ( 1 - cos \frac{2 π l}{L} ) \qquad Formula ( 3 )$$

When integration is performed while paying attention to the boundary condition described above, the curvature is expressed by Equation (4), and has a shape expressed by a sum of a linear function and a sine function.

$$\frac{1}{r} = \frac{1}{R L} ( 1 - \frac{L}{2 π} sin \frac{2 π l}{L} ) \qquad Formula ( 4 )$$

Curve C: Quadratic function

In the curve C, a differentiation (1/r)′ of the curvature is expressed by the following Equation (5). Since it is a quadratic function of 1, it is called a quadratic function curve.

$$\frac{d}{dl} ( \frac{1}{r} ) = \frac{6 l}{{RL}^{2}} ( 1 - \frac{l}{L} ) \qquad Formula ( 5 )$$

When integration is performed while paying attention to the boundary condition described above, the curvature is expressed by Equation (6), and becomes a cubic function.

$$\frac{1}{r} = \frac{1}{R} ( \frac{3 {l}^{2}}{{L}^{2}} - \frac{2 {l}^{3}}{{L}^{3}} ) \qquad Formula ( 6 )$$

Curve D: Linear function

The curve D is represented by two different linear functions with 1=L/2 as a boundary, and is called a linear function curve, as a differentiation (1/r)′ of the curvature is represented by Equations (7) and (8).

$$\frac{d}{dl} ( \frac{1}{r} ) = \frac{4 l}{{RL}^{2}} ( l ≦ \frac{L}{2} ) \qquad Formula ( 7 )$$

$$\frac{d}{dl} ( \frac{1}{r} ) = \frac{4 ( L - l )}{{RL}^{2}} ( l > \frac{L}{2} ) \qquad Formula ( 8 )$$

When integration is performed while paying attention to the boundary condition described above, the curvature is expressed by Equations (9) and (10), and is expressed by two different quadratic functions with 1=L/2 as a boundary, which is referred a quadratic function curve.

$$\frac{1}{r} = \frac{2 {l}^{2}}{{RL}^{2}} ( l ≦ \frac{L}{2} ) \qquad Formula ( 9 )$$

$$\frac{1}{r} = \frac{1}{R} - \frac{2 {( L - l )}^{2}}{{RL}^{2}} ( l > \frac{L}{2} ) \qquad Formula ( 10 )$$

In any of the four types of curves A, B, C, and D described above, it can be easily confirmed that 1/r=0 and (1/r)′=0 are satisfied at 1=0, and 1/r=1/R and (1/r)′=0 are satisfied at 1=L.

Referring to FIG. 2, for each of bent waveguides with these four types of curves A, B, C, and D, when connected to the linear waveguide in which 1/r=0 at 1=0 (point P), smooth variation in curvature is enabled. Furthermore, when a connection is made with its inverted curve having r=R at 1=L (point Q), for example, when the curve A and the inverted curve A are connected, smooth variation in curvature is enabled. On the other hand, since the product of the curvature radius r and the length 1 is constant from the definition of the clothoid curve, the curvature 1/r and the length I have a proportional relationship as illustrated in FIG. 2(a). The differentiation (1/r)′ of the curvature does not become 0 at any of the lengths 1 of the bent waveguide, as illustrated in FIG. 2(b). That is, in the clothoid curve, the variation in curvature is continuous but not smooth at the connection with the front and rear linear waveguides. For four types of curves A, B, C, and D, a value obtained by differentiating a curvature along a waveguide is 0 at one end 1=0 and the other end 1=L of a bent waveguide, which is different from the clothoid curve.

The ends (end points) of the four types of curves A, B, C, and D illustrated in FIG. 2 refer to a starting point and an ending point in a case where each curve is expressed by a mathematical expression, and correspond to the point P and the point Q of the bent waveguide of the clothoid curve of FIG. 1. Thus, turning the curve of the curvature and its differential value in FIG. 2 back symmetrically at the line 1=L represents a 90°-bent waveguide. Both ends of the bent waveguide are continuously connected to the linear waveguide to form a part of the optical circuit.

The bent waveguide of the present disclosure is accordingly configured in which the curvature radius r gradually varies from a first value at a first end (R1, point P) to a second value at a second end (R2, point Q), the curvature is represented by the reciprocal 1/r of the curvature radius, and the differential coefficient obtained by differentiating the curvature with the length 1 along the waveguide is 0 at the first end and the second end.

How to derive x and y coordinates in a Cartesian coordinate system when these four types of curves A, B, C, and D are actually drawn as an optical circuit pattern will be described. In the above Equations (2), (4), (6), (9), and (10), the bent waveguide is expressed by the curvature radius r that is a function of the length 1. The four types of curves A, B, C, and D are expressed by x(1) and y(1) in Cartesian coordinates via an angle θ to be described later.

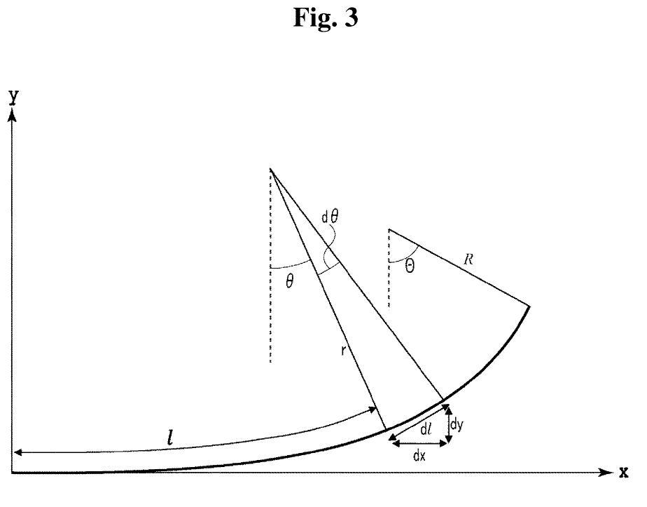

FIG. 3 is a diagram illustrating derivation of coordinate values in a case where four types of curves are drawn in a Cartesian coordinate system. At a certain point on the curve, the curvature radius is r, the length from the starting point is 1, and the angle formed by the normal line of the curve and the y-axis is θ with the counterclockwise rotation being positive. It is assumed that (r, θ, 1)=(0, 0, 0) at the starting point, and the following equation is established at the ending point.

$$( r , θ , l ) = ( R , Θ , L )$$

For a minute portion of a curve, an angle, length, x component of length and y component of the length are denoted as dθ, dl, dx, and dy, respectively.

From FIG. 3, between the polar coordinate system to the Cartesian coordinate system in FIG. 1, the following relationship is established between each parameter.

$$dl = rd θ \qquad Formula ( 11 )$$

$$dx = dl cos θ \qquad Formula ( 12 )$$

$$dy = dl sin θ \qquad Formula ( 13 )$$

The following equation is obtained for 0 from Equation (11).

$$θ = {\int }_{0}^{1} \frac{1}{r} dl \qquad Formula ( 14 )$$

Further, θ in Equation (14) is applied to Equations (12) and (13) to obtain the following equations for the x component of the length and the y component of the length.

$$x = {\int }_{0}^{l} cos ( {\int }_{0}^{l} \frac{1}{r} dl ) dl \qquad Formula ( 15 )$$

$$y = {\int }_{0}^{l} sin ( {\int }_{0}^{l} \frac{1}{r} dl ) dl \qquad Formula ( 16 )$$

Since 1/r is known as, for example, Equation (2) of the curve A, the xy coordinates can be obtained by substituting 1/r into Equations (15) and (16). The integrals of Equations (15) and (16) are generally not analytically solvable, but can be solved by numerical integration.

By applying, for example, Equation (2) to Equation (14) and substituting (1, 0)=(L, Q), the relationship of the following equation is obtained for the length L of the bent waveguide in each of all the curves A, B, C, and D.

$$L = 2 R Θ \qquad Formula ( 17 )$$

Although the derivation is omitted, Equation (17) holds true even in the case of a clothoid curve, and of course L=RΘ in the case of an arc. The total length of each of the clothoid curves and the four curves A, B, C, D is equal to the total length of the arc with a radius (2R) that is twice the minimum bending radius R of these curves. It can be seen that the clothoid curve and the four curves A, B, C, and D have almost the same size.

Next, it will be described that the bent waveguide using the four types of curves A, B, C, and D has a lower loss and inter-mode crosstalk than a bent waveguide using the arc or clothoid curve of the prior art.

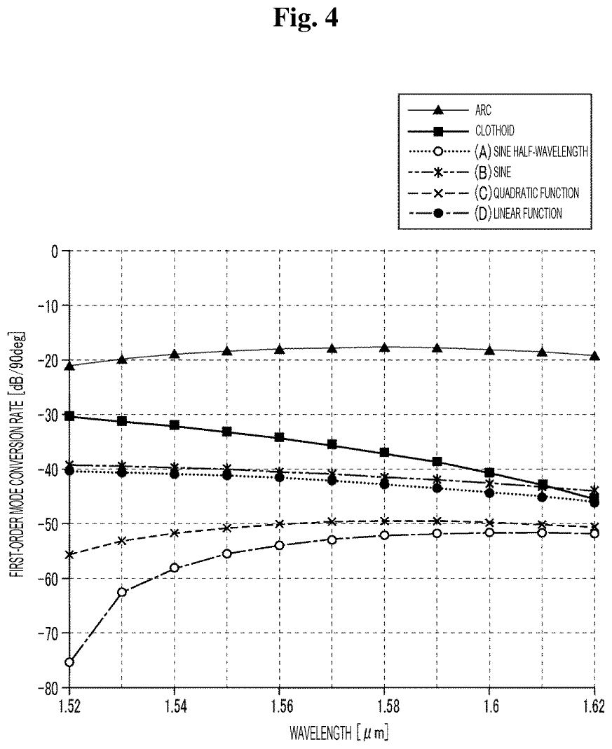

FIG. 4 is a diagram illustrating inter-mode crosstalk characteristics of four types of proposed curves A to D. In each case, a 90°-direction conversion circuit similar to that illustrated in FIG. 1 was fabricated, and a first-order mode conversion rate (dB) obtained by calculating a coupling rate of the light input in the 0th-order mode to the first-order mode was indicated on the vertical axis. The horizontal axis indicates the wavelength (μm). In addition to the four types of curves A to D, cases of arc and clothoid curve are also shown. A core material was Si, a cladding material was SiO₂, a waveguide thickness was 0.22 μm, and a waveguide width was 0.8 μm. The polarized wave is a TE-polarized wave. The bending radius was set to 10 μm for the arc and 5 μm, which is half of the length L of the bent waveguide, according to the relationship of the length L of the bent waveguide described above in order to match the total length of the curve.

Referring to FIG. 4, the coupling factor to the first-order mode at a wavelength of 1.55 μm was-18.3 dB for the arc, −33.2 dB for the clothoid, −55.6 dB for the sine half-wavelength (A), −40.1 dB for the sine (B), −50.8 dB for the quadratic function (C), and −41.3 dB for the linear function (D). Even in the case of the clothoid, the first-order mode coupling factor is greatly reduced as compared with the arc, however all of the bent waveguides according to the curves A, B, C, and D of the present disclosure have the first-order mode coupling factor lower than that of the clothoid. In particular, it can be seen that the inter-mode crosstalk characteristic is better than that of the clothoid curve by not less than 22 dB in the direction conversion circuit using the sine half-wavelength curve A. This superiority was confirmed in almost the entire C-band and L-band of the wavelength band often used for communication.

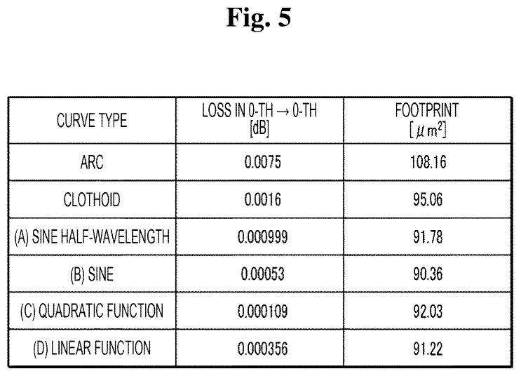

FIG. 5 is a table for comparing zero-order mode losses of bent waveguides according to four types of curves A to D. The loss (dB) of the 0th-order mode at a wavelength of 1.57 μm is illustrated, which is the same as the comparison of the inter-mode crosstalk characteristics in FIG. 4. Regarding the transmittance loss, all of the bent waveguides according to the curves A to D have a lower loss, that is, a higher transmittance than the arc and the clothoid. Table 1 also shows the footprint, and the footprint, i.e. the area size occupied by the bent waveguide, is also notable. When the curve lengths are the same, it can be seen that the footprints of the four types of curves A to D are all smaller than those of the arc and clothoid curve. As is clear from the table shown in FIG. 5, the bent waveguides according to the four types of curves A to D are superior to the arc and clothoid curves in terms of low loss of the 0th-order mode, low coupling rate to the first-order mode, and small footprint.

Comparative evaluation of the inter-mode crosstalk characteristic in FIG. 4 and the loss of the 0th-order mode in FIG. 5 is performed with a waveguide width of 0.8 μm (800 nm). The waveguide width of 0.8 μm is wider than the single-mode condition. The bending loss at the waveguide width satisfying the single-mode condition of the bent waveguide according to the four types of curves A to D is evaluated.

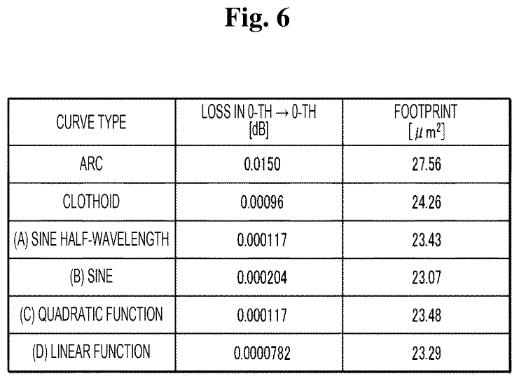

FIG. 6 is a table for comparing the 0th-order mode loss under the single-mode condition of the bent waveguide according to the four curves. The comparison of the table shown in FIG. 6 is a table illustrating the 0th-order mode coupling rate when the waveguide width is 500 nm so as to satisfy the single mode condition and the minimum bending radius is 2.5 μm (5 μm only for the arc). Since bending is tolerated under the single mode condition, evaluation was performed with the minimum bending radius smaller than that in the case of the waveguide width of 800 nm in FIGS. 4 and 5.

Also in the table of FIG. 6, the bent waveguides according to the curves A, B, C, and D of the present disclosure have the 0th-order mode loss lower than those of the arc and clothoid curve. For the footprint, the bent waveguides according to curves A, B, C, D are all smaller than the arc and clothoid curve.

As described above, the bent waveguide according to the curves A, B, C, and D of the present disclosure can suppress the coupling to the higher mode to be lower than that in the prior art even in the width under the multimode condition. Therefore, the advantageous effects of the wide waveguide such as suppression of loss/reflection and suppression of a non-linear effect can be obtained even in the bent waveguide portion, and the overall device performance can be improved. In addition, the optical loss of the 0th-order mode is also lower than that of the prior art. This low loss property can be obtained not only by the waveguide width under the multimode condition, and also from the waveguide under the single mode condition. The footprint is also smaller than the bent waveguide according to the prior art, thus contributing to downsizing of the device.

In the above description, the configuration of the bent waveguide portion has been described by mathematical expression. However, by using these bent waveguides, it is possible to configure a direction conversion circuit in which the two regression curves 102-1 and 102-2 as described in FIG. 1 are coupled to the front and rear linear waveguides 101-1 and 101-2 with low loss. That is, the direction conversion circuit can be achieved by two linear waveguides and two bent waveguides according to the curves A, B, C, and D therebetween. The two bent waveguides are inverted from each other at the connection. A direction conversion circuit is configured by a first linear waveguide; a first bent waveguide connected to the first linear waveguide at the first end; and a second bent waveguide connected to the second end of the first bent waveguide and having a shape obtained by inverting the first bent waveguide; and a second linear waveguide connected at a first end of the second bent waveguide. The direction conversion circuit illustrated in FIG. 1 is a 90°-direction conversion circuit, but if the differential value of the curvature is set to 0 at the two ends of the bent waveguide, the direction conversion circuit can also be applied to direction conversion at an angle less than 90°.

In the bent waveguide according to the curves A, B, C, and D, the curvature continuously varies, and the differential value of the curvature (1/r) becomes zero at the two ends of the bent waveguide, so that the optical loss and the inter-mode crosstalk can be suppressed. Therefore, not only these four curves, but also a bent waveguide having a similar effect can be used.

### INDUSTRIAL APPLICABILITY

The present invention can be used for optical circuits.

1. A bent waveguide, wherein
a curvature radius r gradually varies from a first value (R1) at a first end to a second value (R2) at a second end,
a curvature is represented by the reciprocal 1/r of the curvature radius, and
a differential coefficient obtained by differentiating the curvature with a length 1 along the waveguide is 0 at the first end and the second end.

2. The bent waveguide according to claim 1, wherein a width of the waveguide is a width satisfying a multimode condition.

3. The bent waveguide according to claim 1, wherein the differential coefficient is represented by:
$$\frac{d}{dl} ( \frac{1}{r} ) = \frac{π}{2 RL} sin \frac{π l}{L}$$
where L denotes a total length of a curve and R denotes a minimum bending radius.

4. The bent waveguide according to claim 1, wherein the differential coefficient is represented by:
$$\frac{d}{dl} ( \frac{1}{r} ) = \frac{1}{RL} ( 1 - cos \frac{2 π l}{L} )$$
where L denotes a total length of a curve and R denotes a minimum bending radius.

5. The bent waveguide according to claim 1, wherein the differential coefficient is represented by:
$$\frac{d}{dl} ( \frac{1}{r} ) = \frac{6 l}{{RL}^{2}} ( 1 - \frac{l}{L} )$$
where L denotes a total length of a curve and R denotes a minimum bending radius.

6. The bent waveguide according to claim 1, wherein the differential coefficient is represented by:
$$\frac{d}{dl} ( \frac{1}{r} ) = \frac{4 l}{{RL}^{2}} ( l ≦ \frac{L}{2} )$$
$$and$$
$$\frac{d}{dl} ( \frac{1}{r} ) = \frac{4 ( L - l )}{{RL}^{2}} ( l > \frac{L}{2} )$$
where L denotes a total length of a curve and R denotes a minimum bending radius.

7. A direction conversion circuit, comprising:
a first linear waveguide;
a first bent waveguide according to claim 1, the bent waveguide being connected to the first linear waveguide at the first end; and
a second bent waveguide connected to the second end of the first bent waveguide and having a shape obtained by inverting the first bent waveguide; and
a second linear waveguide connected at a first end of the second bent waveguide.

8. The direction conversion circuit according to claim 7, wherein the first bent waveguide and the second bent waveguide each correspond to a direction conversion of 45° and achieve a bending of 90°θ in total.
